(19) United States
(12) Patent Application Publication
(10) Pub. No.: US 2015/0234958 A1
(43) Pub. Date: Aug. 20, 2015

(54) SELF-SHIELDING TANK

(71) Applicant: Chicago Bridge & Iron Company, Plainfield, IL (US)

(72) Inventors: Susan Juskiewicz, Minooka, IL (US); Justin Kline, Bloomfield, NJ (US)

(73) Assignee: CHICAGO BRIDGE & IRON COMPANY, Plainfield, IL (US)

(21) Appl. No.: 14/182,953

(22) Filed: Feb. 18, 2014

(51) Int. Cl. G06F 17/50; F41H 5/24

(52) U.S. Cl. CPC G06F 17/5018; F41H 5/24

(57) ABSTRACT

A method of designing a self-shielding tank is disclosed. The method includes calculating a wind pressure loading and a projectile impact loading for the tank. Finite element analysis results are generated for the tank based on the calculated wind pressure loading and projectile impact loading. Tank geometry and features based on analysis results are determined and compared to acceptance criteria. The generated finite element analysis results are limited by a specified degree of plastic deformation.

### FIELD OF THE DISCLOSURE

Embodiments disclosed herein relate generally to storage tanks that can withstand an external event (e.g., external pressures, impact loading, etc.) without loss of containment or functionality. Embodiments disclosed herein also relate generally to methods of designing such storage tanks.

### BACKGROUND

To ensure the safety of nuclear power plants in the event of a certain natural disasters or unexpected strikes, the Nuclear Regulatory Commission (NRC) has various regulations that must be met when designing components for a nuclear power plant. For example, in the event of a tornado strike, NRC regulations require that nuclear power plant designs consider the impact of tornado-generated missiles (i.e., objects moving under the action of aerodynamic forces induced by the tornado wind), in addition to the direct action of the tornado wind and the moving ambient pressure field. Wind velocities in excess of 34 m/s (75 mph) are capable of generating missiles from objects lying within the path of the tornado wind and from the debris of nearby damaged structures.

These criteria generally specify that structures, systems and components (SSCs) that are important to safety be provided with sufficient, positive missile protection (e.g., barriers) to withstand the maximum credible threat. The threat may be naturally occurring or man-made. The commonly proposed solution is to build a hardened structure, or barrier, around the entirety of the SSCs which can with-stand these forces to prevent loss of capability of the SSCs to perform their safety function. The NRC provides procedures for the prediction of local damage in the impacted structures, shields, and barriers to withstand the effects of missile impact of the plant. This includes estimation of the depth of penetration and, in case of concrete barriers, the potential for generation of secondary missiles by spalling or scabbing effects. The NRC also provides procedures for the prediction of the overall response of the barrier or portions thereof due to the missile impact. This includes assumptions on acceptable ductility ratios where elasto-plastic behavior is relied upon, and procedures for estimation of forces, moments, and shears induced in the barrier by the impact force of the missile.

Protection from a spectrum of missiles (ranging from a massive missile that deforms on impact to a rigid penetrating missile) provides assurance that the necessary structures, systems, and components will be available to mitigate the potential effects of a tornado on plant safety. Given that the design-basis tornado wind speed has a very low frequency, to be credible, the representative missiles must be common items around the plant site and must have a reasonable probability of becoming airborne within the tornado wind field.

### SUMMARY OF THE DISCLOSURE

In one aspect, embodiments disclosed herein relate to a method of designing a self-shielding tank. The method includes calculating a wind pressure loading and a projectile impact loading for the tank, generating finite element analysis results for the tank based on the calculated wind pressure loading and projectile impact loading, determining tank geometry and features based on analysis results, and comparing the analysis results to acceptance criteria. The generated finite element analysis results are limited by a specified degree of plastic deformation.

In an alternate embodiment, the method includes calculating a wind pressure loading and a projectile impact loading for the tank, generating hand-calculated or non-finite element analysis approximated results for the tank based on the calculated wind pressure loading and projectile impact loading, determining tank geometry and features based on analysis results, and comparing them to acceptance criteria. The generated results are limited by a specified degree of plastic deformation.

In another aspect, embodiments disclosed herein relate to a self-shielding storage tank. The tank has a cylindrical outer wall configured to permanently deform under a specified loading by allowing a limited degree of plastic deformation in the cylindrical outer wall and/or roof.

In another aspect, embodiments disclosed herein relate to a method of manufacturing a tank. The method includes analyzing a tank configured to withstand a specified loading and a specified projectile impact loading, generating analysis results of the tank having an allowable deformation limit, and manufacturing the tank according to the determined tank geometry and features based on analysis results.

Other aspects and advantages will be apparent from the following description and the appended claims.

### BRIEF DESCRIPTION OF DRAWINGS

FIG. 1 is a schematic view of a self-shielding tank according to embodiments herein.

FIG. 2 is a flowchart of a method of manufacturing a tank according to embodiments herein.

### DETAILED DESCRIPTION

In one aspect, embodiments disclosed herein relate generally to a self-shielding tank and methods for designing the self-shielding tank. More specifically, embodiments disclosed herein relate generally to storage tanks that can withstand an external event (e.g., external pressures, impact loading, etc.) without loss of containment or functionality and methods of designing such tanks. The embodiments are particularly useful in nuclear power plants and may be able to be self-shielding from missiles such as wood planks, metal rods, utility poles, automobiles, etc., generated by high-speed winds, such as tornado, hurricane, and any other extreme winds without the need for a separate structure surrounding the tank.

The design process of the tank typically includes determining the maximum energy absorbing properties of plates used in the process of building the tank. These energy absorbing plates provide missile protection necessary to withstand the maximum credible threat without loss of functionality or containment, perhaps by permanent deformation.

The NRC has enacted rules that require the tanks that hold the emergency water supply to fill reactors in case of a disaster in nuclear plants be able to withstand certain extreme conditions, such as tornado-missile criteria or wind criteria. The commonly proposed solution was to build a hardened structure around the entirety of the tank and the associated equipment that can with stand and or absorb the energy of these forces. The tank must also meet two criteria: 1) no loss of containment during the loading, i.e., no breach; and 2) maintain functionality, i.e., the product should be delivered in an emergency.

The tank and associated equipment within the structure have previously been built without considering effect from tornado-missile criteria or wind criteria. The NRC regulations do not specify the tank must remain in the “as-built” condition. The NRC regulations also do not specify that the tank must be built within a structure or behind a barrier.

Previous assumptions made in the design of tanks assumed that deformation analysis on the tank itself were unacceptable. These assumptions may have been due to the fact that designers chose to protect the tank as if it were an egg shell, not because the tank was brittle with no elastic or plastic properties but due to several factors. For example, flat bottom tanks are designed to API 650, API 620, or AWWA codes which do not address projectile loading. Due to the code's silence on projectile loading, engineers have been deterred from designing tanks for projectile loading. Furthermore, the NRC specification titled “Standard Review Plan 3.5.3 Barrier Design Procedures” includes simple equations used to determine plate thickness to withstand small projectiles. The title leads to the assumption that the equipment would be designed to have exterior protection not designing the equipment itself to be self-protecting.

Projectile loading is rarely specified for storage tanks. When specified, many clients and engineers generally assume the equipment cannot be analyzed properly to ensure no puncture or breach. Most protective barriers and buildings at nuclear plants are typically constructed of reinforced concrete. While the NRC has approved equations for determining a thickness for a steel barrier, there is no specification for when the barrier should be constructed of steel or reinforced concrete.

Tanks previously designed using FEA analysis used constraints that limited the analysis to a tank without deformation or before failure. Tanks are typically taken off-line if they become deformed or fail and are then fixed or replaced. Therefore, during normal operation, tanks are not designed to be operable after deformation or failure. However, in emergency situations, such as those which may occur in a nuclear plant, the inventors of the present application found that such tanks should be operable during the emergency situation, regardless of deformation which may occur.

Approaches, such as using equations without FEA may require a larger safety factor. An added layer of safety to this protection system would be to use the specified equation to design a barrier rather than the equipment itself. A barrier could be destroyed as long as it absorbed the energy that would have otherwise been directed toward the equipment. A barrier is not as critical as the equipment itself.

Surprisingly, embodiments of the present application provide a method of designing a tank that complies with the NRC regulations (i.e., the tank maintains containment and functionality) that is capable of plastically deforming without breach under the specified loading without a barrier. In accordance with the present application, in some embodiments, the tank may be designed by limiting the degree of plastic deformation in the tank shell such that the shell can permanently deform without breach under the specified loading. In some embodiments in accordance with the present application, tanks may be built beyond a normal design basis to include a spectrum of projectile loading such that particular criteria are met. Examples of typical projectiles include the following: steel rod (9 lbs @ 300 mph), cedar fence post (33 lbs @ 150 mph), corrugated sheet of siding (100 lbs @ 225 mph), bolted wood decking (450 lbs @ 200 mph), 12″ pipe (750 lbs @ 105 mph), and vehicles (4000 lbs @ 50 mph).

The response of a structure or barrier to missile impact depends largely on the location of impact (e.g., midspan of a slab or near a support), on the dynamic properties of the tank and projectile missile, and on the kinetic energy of the missile. In general, the assumption of plastic collisions has been acceptable, where all of the missile's initial momentum is transferred to the tank and only a portion of its kinetic energy is absorbed as strain energy within the tank. However, where elastic impacts may be expected, the additional momentum transferred to the tank by missile rebound should be considered in the analyses.

Known methods which demonstrated the missile would not penetrate the tank, provided an equivalent static load concentrated at the impact area, from which the structural response, in conjunction with other design loads, was evaluated using conventional design methods. Acceptable procedures for such an analysis, where the impact is assumed to be plastic, is presented in “Impact Effect of Fragments Striking Structural Elements,” Holmes and Narver, Inc., Revised November 1973 by R. A. Williamson and R. R. Alvy. Other procedures may be used, with adequate justification provided the results obtained are comparable to that of the above reference.

Two basic approaches have been used to characterize tornado-generated missiles (1) a standard spectrum of tornado missiles, and (2) a probabilistic assessment of the tornado hazard. No definitive guidance has been developed for use in characterizing site-dependent tornado-generated missiles by hazard probability methods. The damage to safety-related structures by tornado or other wind-generated missiles may imply the occurrence of a sequence of random events. That event sequence typically includes a wind-based occurrence in the plant vicinity in excess of 34 m/s (75 mph), existence and availability of missiles in the area, injection of missiles into the wind field, suspension and flight of those missiles, impact of the missiles with safety-related structures, and resulting damage to critical equipment. Given defense-in-depth considerations, the uncertainties in these events preclude the use of a probabilistic assessment as the sole basis for assessing how well the plant is protected against tornado missile damage. In some embodiments in accordance with the present application, the missiles and conditions may not be limited to tornadoes, but may include other natural or man-made disasters.

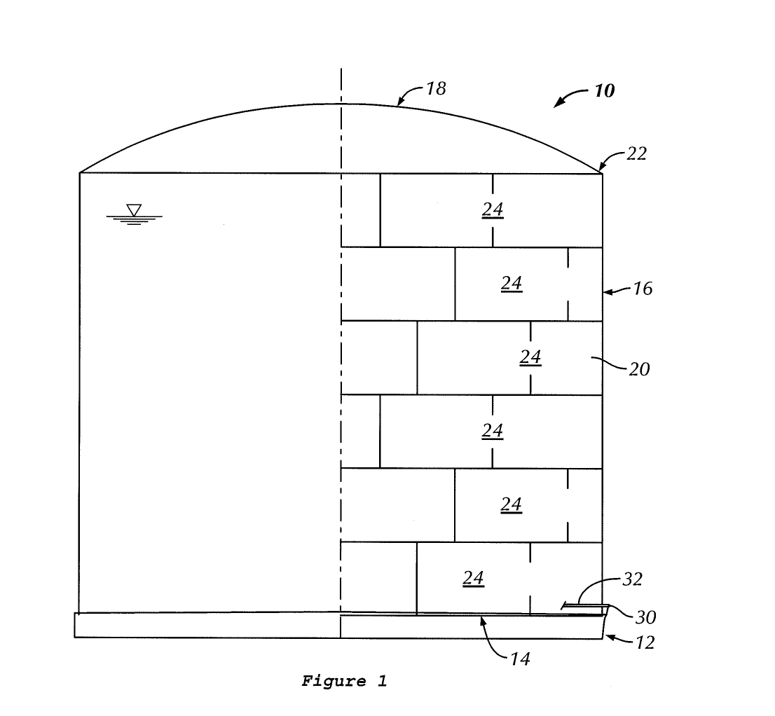

FIG. 1 illustrates an embodiment of a storage tank 10 supported on a foundation 12. The tank 10 has a bottom plate 14 made up of a plurality of plates. The tank 10 has a circular cylindrical side wall 16 and a roof 18. The circular cylindrical side wall 16 may include a plurality of rings 24. Each ring 24 may include a plurality of plates 20. In some embodiments, the roof 18 may also include a plurality of plates. The inlet and outlet piping, vents and other appurtenances may be located on roof 18, bottom 14 or cylindrical side wall 16.

The tank 10 may either be a single wall tank or a double wall tank. The tank 10 size and dimensions may be adjusted for capacity and limitations required on a case-by-case basis. The illustrated tank 10 is a single wall storage tank that can be used to store liquids. In other embodiments, the tank 10 can be used to store cryogenic liquids. In some embodiments, the tank 10 may be a floating roof tank.

The foundation 12 may be a reinforced concrete slab on a grade foundation. Other arrangements can be used such as a reinforced concrete ring-wall with soil fill in the interior, or a slab on a deep foundation (e.g.. piles, piers, etc.). The foundation 12 may include, but are not shown, drains, reinforcement bars, anchor straps, anchor bolts, vertical pre-stress ducts, and annular embeds such as plates, channels, or angles as needed.

The bottom plate 14 may be made of any materials typically used in tanks, such as metal. The underlying support of the bottom plate 14 may be made of any materials typically used in tanks, such as, but not limited to concrete slab, cellular glass insulation, a concrete or wood bearing block, sand or concrete leveling layers, etc. The bottom plate 14 will be joined to the cylindrical side wall 16, such as by welding. The shape of the bottom plate 14 may provide resistance to sliding due to base shear generated from high seismic and/or tornadic loads. In some embodiments, the bottom plate 14 may be a cone-up bottom. The height of the cone-up bottom can be varied or eliminated depending on the applied loads. In some embodiments in accordance with the present application, the bottom plate may be any shape which would resist sliding.

The roof 18 may be supported by, and joined to, the side wall 16. The roof 18 and side wall 16 may be joined, such as by welding. The roof 18 may be a steel dome roof, an umbrella roof, a cone roof with or without column supports or any other roof known in the art.

The side wall 16 can vary from about 8 feet to about 300 feet in height and can be made of any suitable material. In some embodiments, the side wall 16 or the bottom plate 14 can be made of ¼inch to 2 inch thick metal plates 20. The side wall 16 may be joined to the foundation 12 via a plurality of anchorage elements 30 going through a ring 32 which surrounds the bottom of the side wall 16. The plurality of anchorage elements 30 may be spaced evenly around the circumference of the ring 32 or may be spaced at varying intervals. The number and size of anchorage elements 30 may be adjusted based upon the uplift loading. The ring 32 may also be welded between the anchor bolts 30 to aid in the absorption of impact from missiles on the lower part of the side wall 16. The ring 32 may be parsed into discrete elements, often called anchorage “chairs”, or may be removed in its entirety if not needed for aid in the absorption of impact or for support of the anchorage elements. In some embodiments, the anchorage elements 30 may be anchor bolts.

A tank wall thickness may be selected based on the minimum thickness necessary to prevent perforation of the tank wall by the specified wind borne projectiles (meeting or exceeding the projectiles specified in NRC Regulatory Guide 1.76). This selected tank wall thickness is then verified to be adequate for the specified wind, seismic, and other loadings. Finite Element Method (FEM) analysis is then performed to verify the various components of the tank are adequate (e.g. no loss of, or inability to deliver, tank contents) for the larger projectile loadings (e.g. automobile impact). The tank wall is shown to plastically deform, but maintain structurally integrity (e.g. the tank does not tear, collapse, slide, or tip over). The shell to bottom weld is shown to remain intact, with no loss of tank contents. The tank anchorage attachments to the tank wall are shown to remain intact with no breach of the tank wall.

Previously, tanks were designed with the assumption that any deformation was unacceptable because it was difficult to determine how much strain each plate 20 of the tank 10 could take before catastrophic failure. In some embodiments in accordance with the present application, the plates 20 may be designed to absorb energy to a point of permanent deformation, prior to breach. The design of the plates 20 uses known analysis techniques which can model the plates 20 to determine at what load the tank 10 will meet catastrophic failure. This analysis will also determine how much energy the plates 20 can absorb as plastic deformation. In some embodiments, finite element analysis may be used to model the plates 20.

In some embodiments in accordance with the present application, the plastic deformation of the tank 10 is a result of absorbing the energy of the missile or projectile. The tank 10 may then be constructed based on a constraint of the analysis results that the plates 20 may reach plastic deformation, but not break. Therefore, the tank 10 is designed (i.e., the thickness of the tank, material properties, diameter, height, number and size of stiffeners, type and size of welds, etc.) to absorb the energy of the projectile, such that the limit of the results of the analysis is set to plastic deformation without breach.

Stress and strain of the plates 20 are determined for the tank 10 using FEM analysis (also referred to as FEA). FEM analysis is a method in which a structure is divided into finite elements to approximate and analyze the stress distribution, deformation, and so forth. Based on FEM analysis, the tank 10 may be designed to plastically deform and/or to absorb the energy applied from the design loads for wind and projectiles. Another method for designing the tank 10 may be to approximate the deformation of the plates 20 by hand calculation or other non-FEA analysis program. An approximation may produce sufficiently conservative results to be considered adequate documentation for the successful resistance to the specified loading.

The design of the tank 10 may limit the degree of plastic deformation in the tank shell to the point that the shell can permanently deform without a breach, crack or tear under the specified loading. Some advantages for allowing a limited degree of plastic deformation include reducing the cost of the deformable tank when compared to providing the tank within a protective structure, the smaller footprint of the deformable tank when compared to providing the tank within a protective structure, a shorter and/or flexible construction schedule of the deformable tank when compared to providing the tank within a protective structure, and the loading that may cause permanent deformation is unlikely so the tank would most likely maintain an as-built condition during the life of service.

In some embodiments, the tank 10 may be designed to meet or exceed the suggested NRC regulations (including maximum tornado wind speeds and wind borne projectiles) stated in NRC Regulatory Guide 1.76.

In some embodiments, the tank may be designed to be permanently deformable but the associated equipment may be housed in an auxiliary building. The auxiliary building may be smaller since the tank will not be housed therein.

In designing a tank, a wall thickness is selected based on the minimum thickness necessary to prevent perforation of the tank wall by the specified wind borne projectiles (meeting or exceeding the projectiles specified in NRC Regulatory Guide 1.76). This tank wall thickness is then verified to be adequate for the specified wind, seismic, and other loadings. A FEM analysis is then performed to verify the various components of the tank are adequate (e.g. no loss of, or inability to deliver, tank contents) for the larger projectile loadings (e.g. automobile impact). The tank wall may be shown to plastically deform, but maintain structurally integrity (e.g. the tank does not tear, collapse, slide, or tip over). The shell to bottom weld is shown to remain intact, with no loss of tank contents. The tank anchorage attachments to the tank wall are shown to remain intact with no breach of the tank wall.

The designs are analyzed using LS-DYNA_{—}971 software available from Livermore Software Technology Corporation (Livermore, Calif.). Other suitable software to perform such FEA includes, but is not limited to, ABAQUS (available from ABAQUS, Inc.), MARC (available from MSC Software Corporation), and ANSYS (available from ANSYS, Inc.).

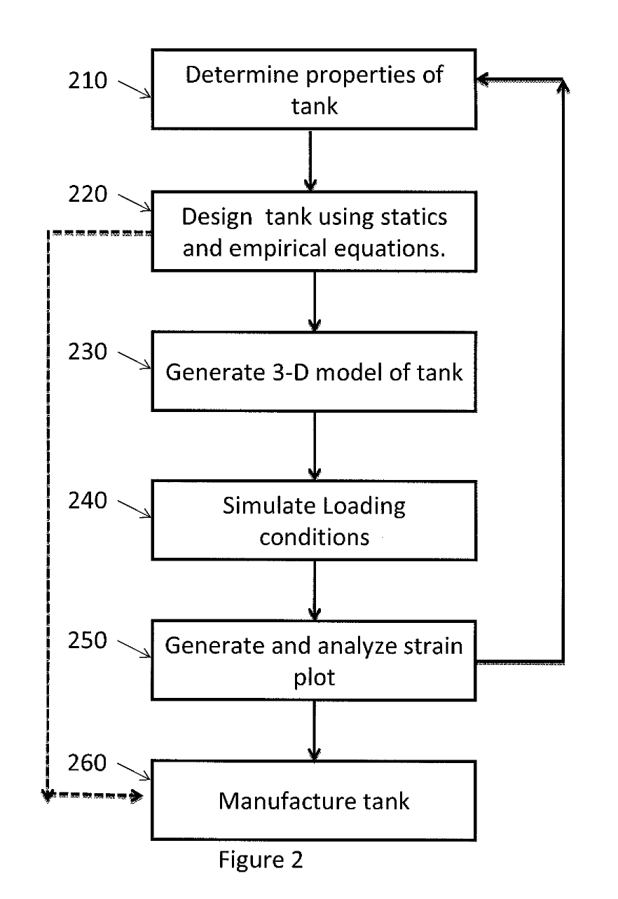

Referring now to FIG. 2, a flow chart for designing a tank is discussed. As a first step 210, the properties of the tank are determined. The properties of the tank materials may either be determined through empirical testing or, in the alternative, may be provided from commercially available material properties data.

Next, the tank is designed with a proprietary tank design program using statics and published empirical equations, to determine a tank configuration and plate thickness 220.

In step 230, a model (i.e., a mesh) for the tank is generated, if warranted by the nature of the specified loading. When generating the model of the tank, design features of the tank are applied to the model. For example, for a tank, the width, height, thickness, and the specific material used for the tank will be input when generating the tank model. In addition, a compression bar (at the roof to shell junction) may be included into the model. The compression bar prevents buckling of the upper portion of the tank wall under internal pressure loading (due to atmospheric pressure drop associated with tornado wind loading). Additional circumferential shell stiffeners may be installed along the height of the tank wall to prevent buckling of the tank wall under external loading. The quantity of stiffeners may be modified to allow for increased external loading on the tank wall.

Alternatively, if the nature of the specified loading does not warrant an FEA model, the design process skips to Manufacture Tank 260.

The tank model may be created in a computer aided design (“CAD”) software package (e.g., AutoCAD available from Autodesk, Inc., and Pro/Engineer available from Parametric Technology Corporation) and imported into the FEA software package or, in the alternative, may be generated within the FEA packages (e.g., ABAQUS and PATRAN) themselves.

Next, dynamic loading conditions are simulated in FEA using model 240. Preferably, these simulated dynamic loading conditions reflect the forces, load states, or strains that the tank may expect to experience in operation. In addition, the model 240 may be set to represent “worst-case” conditions (such as a tornado or missile strike), so that the maximum strains may be modeled.

After simulating dynamic loading conditions, a strain plot showing the strain and deformation occurring in the tank model may be generated and analyzed 250. Ideally, the strain plot shows the location and amount of strain occurring in the tank model in response to the simulated dynamic loading conditions. The strain plot may be analyzed and reviewed 250 to determine the performance characteristics of the tank model, and to determine whether failure would occur.

If the tank model requires improvement, the method may loop back to 210 to determine material properties of another material for the tank (or the thickness may be changed or otherwise modified, or the geometry or other design features of the tank may be modified). This loop allows the model to be further simulated in FEA to determine its performance after further modifications or models. Otherwise, if the tank model is considered acceptable and meets the specified criteria, the tank calculation 220 and the tank model 230 may be used to manufacture a tank 260.

Thus, the FEA model may be used to produce a strain plot of the tank to display the strain concentrations within the tank under specific dynamic loading condition, and identify whether the tank is in acceptable plastic deformation or fails.

In addition, the model may be used to simulate the strain on various sections of the tank (i.e., looking at the strain at specific points such as high on the tank or low on the tank), or can be used to look at the tank as a whole. Moreover, other components may be introduced into the model as necessary to change the structural aspects of the tank. For example, as mentioned above, the thickness of the tank may be changed. In other embodiments, however, other components such as a stiffener, may be introduced to areas where failure may be predicted by hand calculation approximation or the FEA model. For example, the weld points may be subject to high strain as predicted by the model, and a stiffener could be introduced to reinforce this area of potential failure. Those having ordinary skill in the art will recognize that depending on the particular requirement of the tank that the nature of the modification may change. Different grades of steel may be used, multiple layers of differing materials may be used, or other suitable design changes may result from this analysis.

When reviewing the design in the tank model, two principle criteria are used to determine whether the proposed design is a successful one: first, whether the tank, even after permanent deformation, maintains its integrity (i.e., does not leak), and second, whether the tank is still able to function to provide cooling fluid (i.e., access to nozzles is not lost). Subject to these criteria, a design may be validated even if it undergoes significant, irreversible deformation. By using a design process as outlined in FIG. 2, a tank may be designed, in some embodiments, without the need for a secondary, external protective structure such as a reinforced concrete building surrounding the structure.

In one representative embodiment, a single-wall steel dome roof tank (as shown in FIG. 1) was analyzed using the flowchart of FIG. 2. In analyzing the tank, the size and dimensions can be adjusted based on client specifications. The number of shell rings can vary depending on the tank height. A number, size, and/or thickness of circumferential shell stiffeners (which prevent buckling of the tank wall) may be modified in order to satisfy the load conditions. The tank shell thickness can vary depending on wind borne projectile loading. The thickness may be increased to prevent puncture from specified small projectiles. As noted above, (and as shown in FIG. 1), a bottom stiffener may be employed to prevent overstressing the bottom to shell weld due to loading from large projectiles such as an automobile. In the tank shown in FIG. 1, a cone-up bottom is also included for sliding resistance to shear forces generated from earthquakes (or other seismic events), or wind storm events, for example. In addition, radial shear bars may be welded to the underside of the tank bottom and embedded into the tank bottom for additional sliding resistance. Also, the number of anchor bolts may vary depending on the uplift loading. Based on these specifications, analysis of prior art designs and the current design was then performed, with the results being described below.

To further highlight the advantages of the self-shielding tank, comparisons to prior art tanks were evaluated. Prior Art comparative examples 1 and 2 shall be compared with Inventive self-shielding example 1. Each of these examples is based on basic material pricing and installation, and no building is considered, and no margin is included. Prior Art comparative example 3 shall be compared with Inventive Self-shielding example 2. These examples have each been conditioned in a comparable manner for a nuclear facility, include an auxiliary building, and include margin.

Inventive example 1 was a self-shielding steel tank designed such that permanent deformation was allowed. The tank was estimated to be 1 inch thick.

Comparative example 1 was a concrete tank designed with a stainless steel free-standing liner. Based upon the loading, the concrete tank was calculated to be 10 inches thick having a ¼ inch thick free-standing steel liner.

Comparative example 2 was a steel tank, without a protective structure, designed such that no permanent deformation was allowed. The tank was estimated to be 5 inches thick.

Inventive example 2 was a self-shielding steel tank designed such that permanent deformation was allowed and a smaller structure was designed to house FLEX equipment (e.g. generators, hoses, vehicles, etc.). The tank was estimated to be 1 inch thick.

Comparative example 3 was a steel tank having a nominal thickness designed to be enclosed in a large concrete building which includes the FLEX equipment. The tank was estimated to be ¼ inch thick.

See comparison table below:

| | Description | Base price |
|---|---|---|
| Inventive | 1″ thick self-shielding steel tank | $2.0 MM |
| Example 1 | | |
| Comparative | 10″ concrete tank w/ steel free-standing liner | $2.4 MM |
| Example 1 | | |
| Comparative | 5″ thick steel tank (required for no | $5.7 MM |
| Example 2 | permanent deformation) | |
| Inventive | 1″ thick self shielding steel tank w/ smaller | $6.9 MM |
| Example 2 | concrete building for housing FLEX | |
| | equipment. | |
| Comparative | Normal thickness (about ¼″) steel tank | $15.3 MM |
| Example 3 | inside a large concrete building. | |

As shown above, the inventive self-shielding tank examples are much cheaper than those structures previously designed to withstand wind and projectile missiles. Surprisingly, the self-shielding tank examples overcame previously held assumptions. By overcoming the previously held assumption that any deformation in tanks was unacceptable, less material was necessary, thereby making the self-shielding tanks cheaper.

As one of ordinary skill in this art will also recognize, the interior of these self-shielding tanks may have certain accessories and features, including reinforcement gussets or stiffeners welded to the interior side walls, baffles, drains, piping, gages, etc.

Advantageously, the present inventors have discovered that by allowing for some amount of controlled plastic deformation, while maintaining the functionality of the tank, the need for a secondary concrete structure is eliminated for protection of the tank which was previously assumed by ordinary practitioners to be the.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed is:

1. A method of designing a self-shielding tank, the method comprising:
calculating a wind pressure loading for the tank;
calculating a projectile impact loading for the tank;
generating finite element analysis results for the tank based on the calculated wind pressure loading and the calculated projectile impact loading, wherein the generated finite element analysis results are limited by a specified degree of plastic deformation; and
determining tank geometry and features based on analysis results and comparing the analysis results to acceptance criteria.

2. The method of claim 1, wherein the specified degree of plastic deformation correlates to a maximum allowable degree of plastic deformation before loss of containment.

3. The method of claim 1, wherein the finite element results comprise allowing the tank to absorb energy from the specifying the wind pressure loading and the specifying the projectile impact loading.

4. The method of claim 1, wherein the specifying the wind pressure loading comprises meeting the NRC Regulatory Guide 1.76.

5. The method of claim 1, wherein the specifying the projectile impact loading comprises meeting the NRC Regulatory Guide 1.76.

6. The method of claim 1, wherein the specified degree of plastic deformation correlates to a maximum degree of plastic deformation wherein the tank may permanently deform without breach.

7. A method of designing a self-shielding tank, the method comprising:
calculating a wind pressure loading for the tank;
calculating a projectile impact loading for the tank;
generating hand-calculated or non-finite element analysis approximated results for the tank based on the calculated wind pressure loading and the calculated projectile impact loading, wherein the generated results are limited by a specified degree of plastic deformation, and
determining tank geometry and features based on analysis results and comparing them to acceptance criteria.

8. The method of claim 7, wherein the specified degree of plastic deformation correlates to a maximum allowable degree of plastic deformation before loss of containment.

9. The method of claim 7, wherein the method of analysis further comprises allowing the tank to absorb energy from the specifying the wind pressure loading and the specifying the projectile impact loading.

10. The method of claim 7, wherein the specifying the wind pressure loading comprises meeting the NRC Regulatory Guide 1.76.

11. The method of claim 7, wherein the specifying the projectile impact loading comprises meeting the NRC Regulatory Guide 1.76.

12. The method of claim 7, wherein the specified degree of plastic deformation correlates to a maximum degree of plastic deformation wherein the tank may permanently deform without breach.

13. An self-shielding storage tank comprising:
a cylindrical outer wall configured to permanently deform under a specified loading by allowing a limited degree of plastic deformation in the cylindrical outer wall and/or roof.

14. The tank of claim 13, wherein the cylindrical outer wall or roof comprises a plurality of plates.

15. The tank of claim 13, wherein the cylindrical outer wall or roof is further configured to absorb energy determined by the specified loading.

16. The tank of claim 13, wherein the specified loading is a projectile impact loading.

17. The tank of claim 13, wherein the specified loading is a wind pressure loading.

18. A method of manufacturing a tank, the method comprising:
analyzing a tank configured to withstand a specified loading and a specified projectile impact loading;
generating analysis results of the tank having an allowable deformation limit; and
manufacturing the tank according to the determined tank geometry and features based on analysis results.

19. The method of claim 18, wherein the specified loading is a projectile impact loading.

20. The method of claim 18, wherein the specified loading is a wind pressure loading.

21. The method of claim 18, wherein the allowable deformation limit corresponds to a maximum plastic deformation limit without breach of the tank.
